(19) United States
(12) Patent Application Publication
(10) Pub. No.: US 2011/0070143 A1
(43) Pub. Date: Mar. 24, 2011

(54) Hydrogenation Of Polysilicon Nanowires

(75) Inventors: Ronald Paul Hellmer, Round Rock, TX (US); Terry D. Golding, Ardmore, OK (US)

(73) Assignee: Amethyst Research, Inc., Ardmore, OK (US)

(21) Appl. No.: 12/886,805

(22) Filed: Sep. 21, 2010

Related U.S. Application Data
(60) Provisional application No. 61/244,251, filed on Sep. 21, 2009.

(51) Int. Cl. C01B 33/021; B01J 19/12; B82Y 40/00

(52) U.S. Cl. 423/348; 422/186.3; 977/762

(57) ABSTRACT

An apparatus and method for improving the electrical conductivity of a thermoelectric material, particularly a material comprising polysilicon nanowires. The method comprises hydrogenation of the device to improve the electrical conductivity of the device with negligible change to the thermal conductivity. Hydrogenation of the thermoelectric device may be accomplished using several techniques, including UV-assisted hydrogenation in a vacuum chamber.

### CROSS-REFERENCE TO RELATED APPLICATIONS

This application claims priority to U.S. Provisional Patent Application No. 61/244,251, filed Sep. 21, 2009, the contents of which are incorporated herein by reference.

### FIELD OF THE INVENTION

This invention relates to method and apparatus for hydrogenating materials to modify the material's optical, electrical, or mechanical properties or reduce or eliminate the effects of defects within the materials.

### SUMMARY OF INVENTION

The present invention is directed to a method for increasing the electrical conductivity a thermoelectric material comprising hydrogenating the thermoelectric material.

The present invention is also directed to a thermoelectric material having a high electrical conductivity made by the process of hydrogenating the thermoelectric material.

The invention is further directed to a system for hydrogenating a thermoelectric device comprising polysilicon nanowires. The system comprises a chamber having a holder for supporting the material within the chamber, a light disposed to provide UV radiation to the material supported on the holder within the chamber, and a hydrogen gas injection system adapted to inject molecular hydrogen gas into the chamber. UV radiation of the material and hydrogen enhances absorption of atomic hydrogen by the material.

The present invention is further directed to a method for hydrogenating a material containing at least one polysilicon nanowire. The method comprises providing a chamber and a UV light source to provide UV radiation in the chamber, placing the material in the chamber, introducing hydrogen gas into the chamber, and irradiating the material within the chamber with UV radiation with the material and the hydrogen gas present within the chamber to cause absorption of the hydrogen into the material.

Further still, the present invention is directed to a thermoelectric material structure comprising hydrogen diffused along polysilicon nanowire grain boundaries.

### BRIEF DESCRIPTION OF THE DRAWINGS

FIG. 1 is a diagrammatic representation of a system for UV-assisted hydrogenation of a semiconductor material.

FIG. 2 is a chart showing the decomposition of a gallium-nitride material under various experimental conditions.

FIG. 3 is a diagrammatic representation of an apparatus having an internal UV source for UV-assisted hydrogenation of a semiconductor material.

FIG. 4 is a diagrammatic representation of an apparatus for locating a mask and a material to be irradiated with UV.

### DETAILED DESCRIPTION

Within materials hydrogen interacts with broken or weak bonds, such as those found at extended and localized defects to passivate the deleterious effects of such a broken or weak bond. Defects, as used herein, include any structural or chemical variation within the crystalline lattice of the semiconductor that disrupts the three-dimensional repetition of the crystal's unit cell structure. The main result of hydrogenating such defects is the shifting of the energy levels associated with the broken or weak bonds out of the band gap. The band gap separates the valence and conduction band that comprise the electronic energy levels in a semiconductor substantially free from defects. The shift in the energy levels can lead to the passivation of the electrical activity of defects. The consequences of these interactions are substantial changes in the electrical and optical properties of the materials, including transport properties such as carrier mobility/lifetime. Thus, passivation of defects such as dislocations in hydrogenated semiconductor material provides a range of advantages.

One material which benefits from hydrogenation is a thermoelectric (TE) device utilizing polysilicon nanowires. The figure of merit, ZT, for a TE device is given by the equation:

$$Z = \frac{σ {S}^{2}}{κ}$$

where S is the Seebeck coefficient, σ is the electrical conductivity, and κ is the thermal conductivity. In general, the efficiency of the device increases with increasing Z. It is seen that if the electrical conductivity of the material can be increased while the thermal conductivity and Seebeck coefficient remain relatively constant, then the figure of merit, and hence the device efficiency can be improved.

For TE devices that utilize polysilicon nanowires in particular, and for other semiconductor-based TE devices in general, the use of hydrogenation techniques such as that disclosed herein is advantageous for achieving higher electrical conductivity, and thereby increasing the overall figure of merit for the thermoelectric devices.

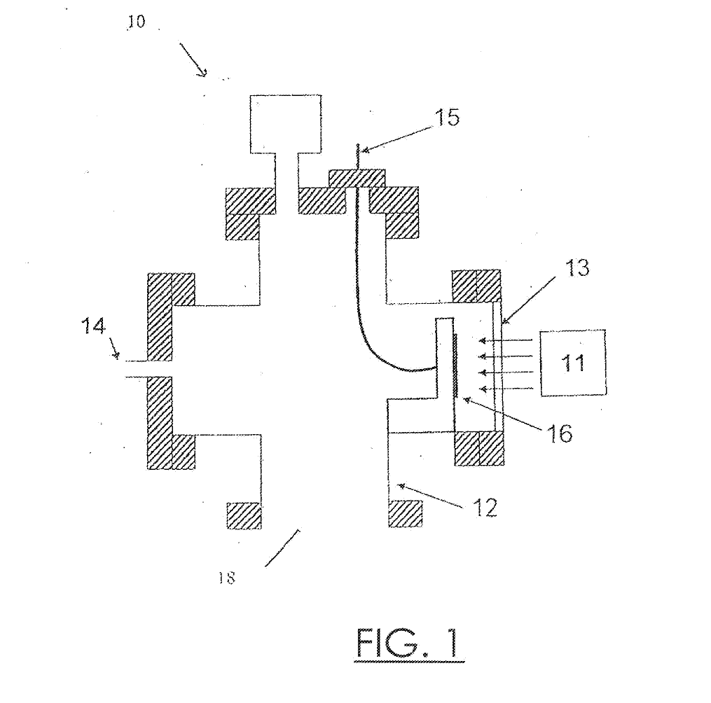

The hydrogenation of polysilicon nanowires can be accomplished by any of the numerous techniques for generating atomic hydrogen, which is known to rapidly diffuse through polysilicon grain boundaries, where the diffusion coefficient is much higher than in the bulk single crystal silicon. These hydrogen generation techniques include RF and DC glow discharge, thermal cracking, hollow cathode, inductively coupled plasma, and microwave glow discharge, and are well-known. In addition, the use of UV induced hydrogenation as shown in FIG. 1 is an especially benign technique that should have minimal impact on the surface of the thin nanowires, as well as any other component structures on the wafer being hydrogenated. The UV hydrogenation technique also allows for easy masking techniques where component structures, for which hydrogenation might be undesirable, can be blocked off from exposure to the UV.

The conductivity of many other semiconductor materials can also be increased by the same type of hydrogenation techniques, in which, not just grain boundaries, but other material defects are electrically passivated by reaction with atomic hydrogen. Therefore the hydrogenation technique is applicable to many other thermoelectric systems based on various materials.

Benefits of hydrogenation include improving the electrical and optical characteristics of a material. The use of UV light to activate hydrogenation of materials offers many advantages over previous techniques used for hydrogenating materials. UV-irradiation activates in-diffusion of hydrogen by activating at least two processes related to hydrogenation. Since hydrogen diffuses in semiconductors in its atomic state (H), rather than as a molecule, molecular hydrogen (H₂) should be dissociated prior to in-diffusion. This can occur in the gaseous phase to increase the atomic hydrogen to molecular hydrogen ratio in the process environment within the chamber discussed below or on the semiconductor surface. Molecular hydrogen adsorbs (stick) on the surface and, once there, can be dissociated. This can occur in semiconductors as a single coordinated process known as dissociative adsorption, which involves molecular dissociation as an integral part of adsorption. UV activated in-diffusion proceeds via photon induced dissociation of molecular hydrogen either in the gas phase and/or adsorbed to the surface. The amount of energy needed to break apart molecular hydrogen adsorbed to the surface of the semiconductor or activate dissociative adsorption is generally less than the amount required to break apart (dissociate) molecular hydrogen in the gaseous phase.

Photon-assisted hydrogenation (PAH) offers a number of unique processing advantages that essentially derive from the unique properties of light. The first involves the directionality of light that can be utilized with a simple shadow masking technique to yield a selective-area process. Selective-area hydrogenation is important since device regions that might be degraded by hydrogenation, e.g. metal runs on a chip, can be protected.

Another advantage of UV activated processing is its selectivity. Selectivity of the process may be controlled by the photon energy (wavelength) chosen to target activation of a specific process to enhance the selected-area processing. An example is the use of a low pressure Hg lamp to activate dissociation of molecular hydrogen in the gaseous phase. A low pressure Hg lamp emits UV radiation in a wavelength range of 185 and 254 nm ideal for dissociating molecular H₂.

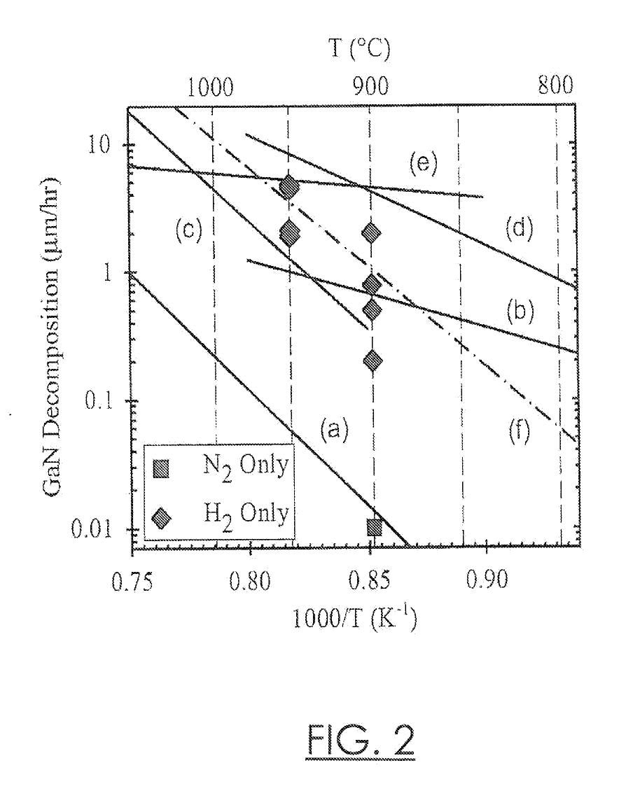

Furthermore, UV-activated hydrogenation is inherently a low-temperature process, especially if the rate-limiting step is molecular hydrogen dissociation. Process temperatures for UV-activated hydrogenation may be below 100 degrees Celsius and preferably are in a range considered “room temperature.” Low-temperature hydrogenation offers a number of advantages. First, it limits hydrogen- or thermal-induced etching of the material or nearby surfaces. For example, hydrogen exposure of a GaN material at high-temperature causes substantial decomposition of the material, as shown in FIG. 2. Low-temperature processing eliminates or reduces this effect. Also, in addition to the minimal etching of the device surface, low-temperature hydrogenation also minimizes etching from all nearby surfaces (chamber walls, substrate mount etc), thereby reducing the risk of redeposition of these materials onto the substrate itself. For example, plasma-activated hydrogenation can leave thin film coatings on ceramic standoffs, as evidenced by discoloration that occurs over time. These problems have not been observed during UV-activated hydrogenation of semiconducting materials. Furthermore, low-temperature processing is desirable since it avoids any thermally-activated chemical or structural changes, such as intermixing in a heterostructure, in the processed material.

Dissociation of hydrogen by UV light also results in the generation of neutral atomic hydrogen. Other techniques such as use of plasma result in substantial amounts of ionized hydrogen (hydrogen ions having either a positive or negative charge). Ionized hydrogen may be more reactive but it also results with charging of the semiconductor material. Charging the material can damage sensitive electronic structures on or within the semiconductor. Thus, UV-activated hydrogenation results in less charging of the semiconductor material during processing and thus reduces or eliminates the possibility of damaging charge-sensitive devices.

Turning again to FIG. 1, an apparatus suitable for UV hydrogenation of a semiconductor is illustrated. System 10 has chamber 12 and UV light source 11, which may be a mercury, deuterium or xenon lamp. The choice of lamp used by the method of the present invention is dictated by its spectral output. For hydrogenation, the spectral output of the lamp should be predominantly at wavelengths less than 300 nm. The dissociation energy of molecular hydrogen corresponds to that of a photon with a wavelength of 275 nm. Thus, a UV lamp having a spectral output at a wavelength of 275 nm or less is preferred to ensure dissociation of hydrogen in the gas phase.

When processing the material at a temperature above room temperature, chamber 12 may be wrapped with heating tape and aluminum foil (not shown) to achieve desired processing temperatures. A heated platen (sample holder) can also be used to achieve the desired temperature of the material during processing. A thermocouple 15 may be positioned within the chamber to measure the temperature of the semiconductor 16.

The UV light emitted from light source 11 may pass into the chamber 12 through a viewport 13. The viewport 13 may comprise 6-inch fused silica to allow transmission of UV light down to wavelengths of about 200 nm. A gas inlet 14 provides for introduction of hydrogen (or deuterium) gas into the chamber 12. An opening 18 connects to a gate valve and a turbo pump (not shown).

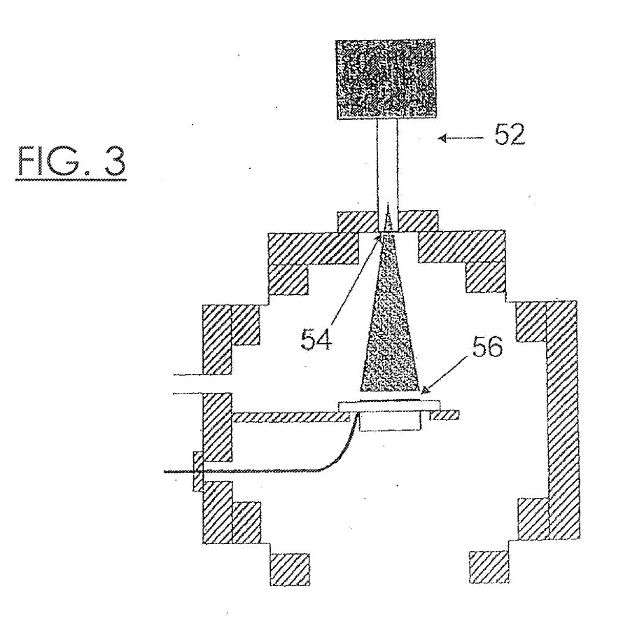

Use of the deuterium lamp allows the UV hydrogenation process to be studied under a completely-different range of wavelengths than either the Xe or Hg lamps. The arrangement shown in FIG. 3 may be used to couple the shortwave UV radiation to the sample surface.

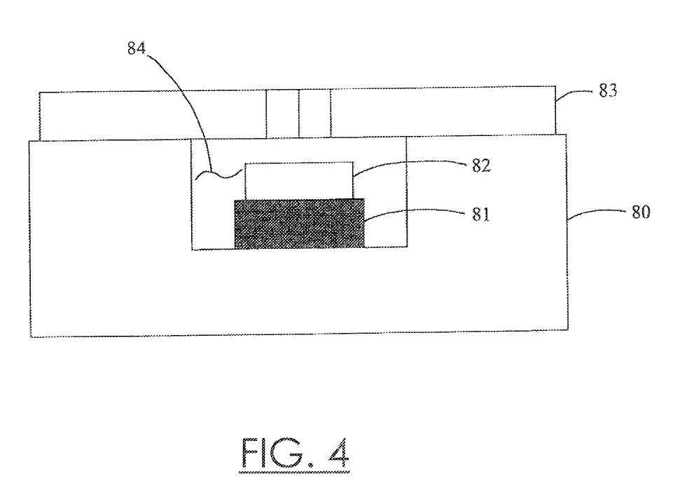

A mount used in accordance with the present invention is shown in FIG. 4. The mount 80 may comprise a solid block of aluminum. The mount 80 includes a recess 84 that may be milled out of the aluminum mount. An X-Y translation stage 81 is mounted inside the recess 84, and APD chip 82 is mounted oil top of the X-Y stage. The X-Y translation stage 81 is used to control movement of the chip 82 within the recess 84. Mask 83 is then mounted to the Al block above the chip 82. The mount 80 is then viewed under a microscope, and micrometer movements on the X-Y translation stage 81 are used to align the openings in the mask 83 with the area selected for hydrogenation.

After alignment is achieved, the X-Y stage 81 may be locked rigidly in place and the whole mount 80 transferred into the hydrogenation chamber 12 (FIG. 1 or 3) and placed under the UV lamp for hydrogenation.

UV photo-assisted hydrogenation has been discussed herein. One skilled in the art will appreciate that the systems and method disclosed herein may be used on devices such as thermoelectric devices comprising polysilicon nanowires.

The method of the present invention comprises providing a vacuum chamber 12 which may be evacuated with a turbo pump after which the sample is heated to the desired temperature and the chamber backfilled with hydrogen (or deuterium) gas. The UV light source may then be ignited and the sample irradiated in the deuterium environment. As discussed above, a portion of the sample may be masked to prevent irradiation of the masked portion. However, in some applications, the entire sample surface may be UV irradiated.

Using the apparatus and procedures disclosed herein a comprehensive UV Hydrogenation Parameter Matrix for the thermoelectric device may be developed. This will allow a user to design and tailor the hydrogenation process for the variety of materials encountered in various devices.

A commercial “plug-and-play” system for Photon-Assisted Hydrogenation (PAH) for treatment of devices may be assembled, using a customized reaction chamber uniquely designed for PAH with masking and alignment capability. The system may comprise a chamber having a holder for supporting the material within the chamber. The UV light source is disposed to provide UV radiation on the holder within the chamber. A hydrogen gas injection system is adapted to inject molecular hydrogen gas into the chamber. UV radiation of the material and molecular hydrogen enhances absorption of atomic hydrogen by the material. The UV light source may comprise a low pressure mercury lamp configured to emit UV radiation at a wavelength in the range from 185 nm to 300 nm.

The present invention includes a method for hydrogenation of a material comprising a semiconductor 16. The method comprises providing a vacuum chamber 12 and a UV light source 11 to provide UV radiation into the chamber. Hydrogen gas is introduced into the chamber and the material is irradiated within the chamber with UV radiation with the material and hydrogen gas present within the chamber to cause absorption of the hydrogen into the material. As discussed above, the material may comprise a semiconductor. However, one skilled in the art will appreciate that UV-assisted hydrogenation may be used to hydrogenate a metal, ceramic, or carbon-based material. The method may further comprise controlling a temperature of the material within a selected range preferable below 900 degrees Celsius and more preferably at room temperature. In accordance with the method of the present invention the hydrogen gas may comprise molecular hydrogen which is dissociated within the chamber as to a result of its exposure to the UV radiation. The dissociation of the molecular hydrogen may include dissociation of the molecular hydrogen adsorbed to the surface of the material. A benefit of UV-assisted dissociation of adsorbed hydrogen is the formation of neutral atomic hydrogen.

Although the present invention has been described with reference to specific details, it is not intended that such details should be regarded as limitations on the scope of the invention, except to the extent that they are included in the claims.

1. A method for hydrogenating a material, the material containing at least one polysilicon nanowire, the method comprising:
providing a chamber and a UV light source to provide UV radiation in the chamber;
placing the material into the chamber;
introducing a hydrogen gas into the chamber; and
irradiating the material within the chamber with UV radiation with the material and hydrogen gas present within the chamber to cause absorption of the hydrogen into the material.

2. The method of claim 1 further comprising controlling a temperature of the material within a selected range.

3. The method of claim 1 wherein UV light source a low-pressure mercury lamp adapted to emit UV radiation at a wavelength of 275 nm or less.

4. The method of claim 3 wherein the hydrogen gas comprises molecular hydrogen, the method further comprising disassociating the molecular hydrogen within the chamber as a result of its exposure to the UV radiation.

5. The method of claim 4 further comprising dissociating the molecular hydrogen on a surface of the material.

6. The method of claim 4 wherein dissociating the molecular hydrogen generates only neutral atomic hydrogen.

7. A system for hydrogenating a thermoelectric device comprising polysilicon nanowires, the system comprising:
a chamber having a holder for supporting the material within the chamber
a light disposed to provide UV radiation to the material supported on the holder within the chamber; and
a hydrogen gas injection system adapted to inject molecular hydrogen gas into the chamber;
wherein UV radiation of the material and hydrogen enhances absorption of atomic hydrogen by the material.

8. The system of claim 7 wherein the light comprises a low pressure mercury lamp configured to emit UV radiation at a wavelength in the range from 185 nm to 254 nm.

9. The system of claim 7 wherein, the chamber comprises a vacuum chamber.

10. A method for increasing the electrical conductivity a thermoelectric material, the method comprising hydrogenating the thermoelectric material.

11. The method of claim 10 further comprising the steps of:
providing a chamber and a source of UV light to provide UV radiation into the chamber;
placing the crystalline material into the chamber;
introducing a hydrogen gas into the chamber; and
irradiating the chamber with UV radiation when the thermoelectric material and hydrogen gas are both present within the chamber to cause absorption of the hydrogen into the crystalline material.

12. The method of claim 11 wherein the thermoelectric material comprises a plurality of polysilicon nanowires.

13. The method of claim 11 further comprising controlling a temperature of the thermoelectric material within a selected range.

14. The method of claim 11 wherein the UV light comprises a mercury lamp adapted to emit UV radiation at a wavelength of 275 nm or less.

15. The method of claim 11 wherein the hydrogen gas comprises molecular hydrogen, the method further comprising disassociating the molecular hydrogen within the chamber with the UV radiation.

16. The method of claim 11 further comprising dissociating the molecular hydrogen on a surface of the thermoelectric material.

17. The method of claim 11 wherein disassociating the molecular hydrogen generates neutral atomic hydrogen.

18. The method of claim 11 further comprising adsorbing molecular hydrogen to a surface of the material and irradiating the surface of the material with the UV light source.

19. A thermoelectric material having a high electrical conductivity made by the process of hydrogenating the material.

20. The product of claim 19 wherein the process of hydrogenating the material comprises the steps of:
providing a chamber and a source of UV light to provide UV radiation into the chamber;
placing the crystalline material into the chamber;
introducing a hydrogen gas into the chamber; and
irradiating the chamber with UV radiation when the thermoelectric material and hydrogen gas are both present within the chamber to cause absorption of the hydrogen into the crystalline material.

21. The product of claim 19 wherein the process of hydrogenating the material comprises producing hydrogen through glow discharge.

22. The product of claim 19 wherein the process of hydrogenating the material further comprises thermal cracking.

23. A thermoelectric material structure comprising hydrogen diffused along polysilicon nanowire grain boundaries.
